(19) United States
(12) Patent Application Publication
(10) Pub. No.: US 2015/0041162 A1
(43) Pub. Date: Feb. 12, 2015

(54) PROGRAMMABLE TORQUE CONTROL METHOD FOR SENSING LOCKING ELEMENT

(71) Applicant: CHINA PNEUMATIC CORPORATION, Chungli (TW)

(72) Inventors: Hsiu-Feng CHU, Chungli (TW); Ming-Zuan TSAI, Chungli (TW)

(73) Assignee: CHINA PNEUMATIC CORPORATION, Chungli (TW)

(21) Appl. No.: 13/960,070

(22) Filed: Aug. 6, 2013

(51) Int. Cl. B25B 23/147; G05D 17/00

(52) U.S. Cl. CPC B25B 23/147; G05D 17/00
USPC 173/1

(57) ABSTRACT

In a programmable torque control method for sensing locking element, at least one sensing locking element and a power torque tool are provided. A s sensed strain signal produced by the sensing locking element is transmitted to a controller of the power torque tool when the sensing locking element is driven by a power torque tool to a desired position and forward and backward rotations of a driving motor of the power torque tool are controlled by the controller, and the forward or backward rotation of the driving motor is determined according to the s sensed strain signal to control a programmable continuous motion until the tightening torque or clamping force reaches to a predetermined target torque value.

### FIELD OF THE INVENTION

The present invention relates to a method of measuring the torque or clamping force of a secured screw element, and more particularly to a programmable torque control method for controlling the tightening torque by means of sensing a locking element.

### BACKGROUND OF THE INVENTION

Screw elements including bolts or washers have been used extensively in various products. The larger the product, the greater the clamping force for tightening the screw elements is required. However, it is an issue of how to know whether the clamping force or torque exerted on a screw element has met the requirements or specifications when components are installed or assembled. In conventional ways, a torque tool is used for tightening the screw element, and then a digital torque wrench or an ultrasonic bolt stress measurement device is used for checking whether a locking element has been tightened with a predetermined torque value. The structure of the screw element is often cracked, broken or damaged by the torque tool due to an excessive force applied by operators. For example, when an excessive force is applied to a car wheel, the clamping force exerted onto the screw element exceeds the yield strength of the screw element, thus causing damages to the structure of the screw elements or even the structure of the rim of the car wheel. Therefore, accidents such as breaking the screw elements occur frequently while a car is driving at high speed or the car has a large external impact. As a result, the rim may be separated from the car wheel to cause serious injuries or damages. In order to tighten the screw elements safely, related regulations and laws of different countries in the world strictly stipulate that all torque tools for tightening the screw elements, the torque should be controllable or it's required to use a digital torque wrench to check if the screw elements are tightened properly. However, using the ultrasonic bolt stress measurement device to check the torque incurs a high cost and an inconvenient operation, so that the method of using the ultrasonic bolt stress measurement device to measure the torque cannot be popular or used extensively.

At present, some manufacturers use devices such as built-in screw sensors, data transmitters and microprocessors for a precise tightening effect, so that the manufacturing cost of the screw elements is increased significantly. In addition, a built-in sensing element of a sensing bolt can be connected to a control device via a cable transmission, and a nut can be secured to the sensing bolt for the locking operation, and the control device is provided for displaying the value of clamping force through the built-in sensing element of the sensing bolt immediately. However, the efficiency of locking the sensing bolt by the torque wrench manually is inefficient, and the operation of connecting the sensing bolt to the control device via cable is inconvenient. If the power torque tightening tool is used for tightening the sensing bolt instead, the efficiency can be improved, but it's hardly to control the torque required under high speed operation for tightening the sensing bolt within a preset range.

The conventional way of tightening the sensing bolt usually fails to measure or apply a clamping force or torque accurately, and the conventional operation is inconvenient.

In view of the aforementioned drawbacks of the prior art, the inventor of the present invention based on years of experience in the related industry to conduct extensive researches and experiments, and finally designed a feasible solution to overcome the drawbacks of the prior art.

### SUMMARY OF THE INVENTION

Therefore, it is a primary objective of the present invention to provide a programmable torque control method for sensing a locking element, wherein the sensing locking element such as a sensing bolt or a sensing washer can achieve a high-precision locking effect by a power torque tool in a high-efficiency locking process.

Another objective of the present invention is to provide a programmable torque control method for sensing a locking element, and the method can monitor the locking condition afterward or can track and inform the locking condition of a sensing locking element to determine whether the locking element is maintained within an expected permissible safety range.

To achieve the aforementioned objectives, the present invention provides a programmable torque control method for sensing a locking element, and the method comprises the following steps:

(a) Provide at least one sensing locking element and a power torque tool, wherein the sensing locking element has a signal transmitting unit, and the power torque tool has a controller for controlling a driving motor of the power torque tool to rotate forward and backward.

(b) Use the power torque tool to lock the sensing locking element to a desired position, and transmit a sensed strain signal generated by the sensing locking element to the signal transmitting unit, and then transmit the sensed strain signal from the signal transmitting unit to the controller.

(c) Provide a target torque value to the controller to compute and compare the sensed strain signal received from the signal transmitting unit by the controller. If the sensed strain signal is smaller than the predetermined torque value, the driving motor will be controlled to rotate forward; and if the sensed strain signal is not smaller than the predetermined torque value, the driving motor will be controlled to rotate backward.

(d) Repeat the step (c) until the sensed strain signal falls into the range of the predetermined torque value, and then stop the driving motor.

### BRIEF DESCRIPTION OF THE DRAWINGS

FIG. 1 is a schematic view of a power torque tool operated to lock a sensing locking element in accordance with the present invention;

FIG. 2 is a schematic view of a sensing locking element applied in a car wheel in accordance the present invention;

FIG. 3 is a block flow diagram of a controller programmable method in accordance with a first preferred embodiment of the present invention; and

FIG. 4 is a block flow diagram of a controller programmable method in accordance with a second preferred embodiment of the present invention.

### DESCRIPTION OF THE PREFERRED EMBODIMENTS

The technical contents of the present invention will become apparent with the detailed description of preferred embodiments accompanied with the illustration of related drawings as follows. It is noteworthy that same numerals are used for representing same respective elements in the drawings.

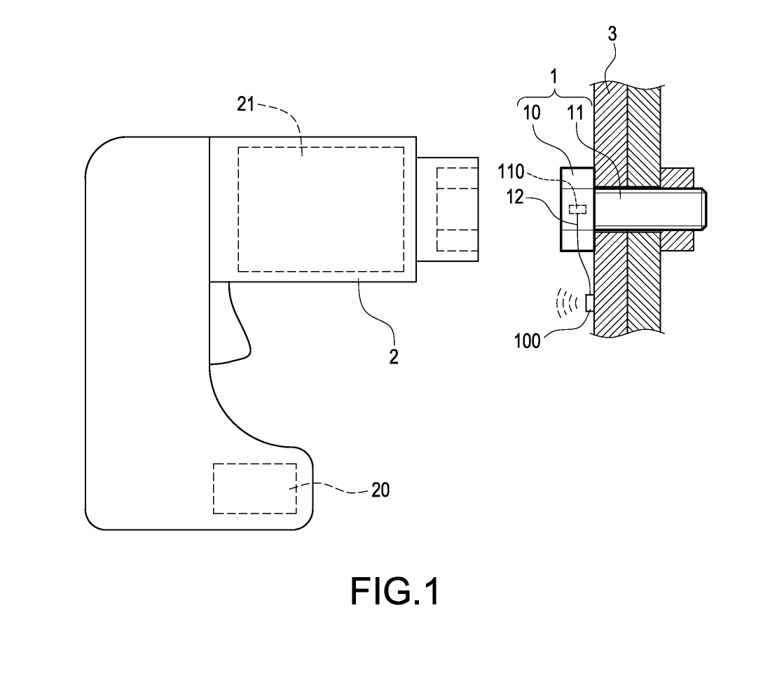

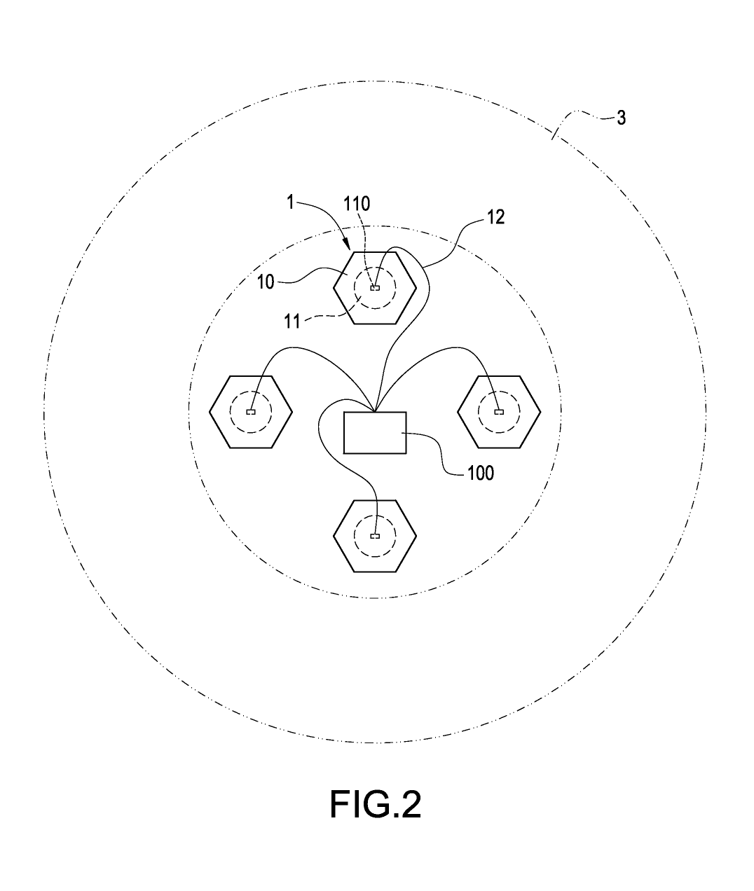

With reference to FIGS. 1 and 2 for a schematic view of a power torque tool operated to lock a sensing locking element and a schematic view of a sensing locking element applied in a car wheel in accordance with the present invention respectively, the present invention provides a programmable torque control method for sensing locking element, wherein a sensing locking element 1 can be locked precisely by a sensing bolt or a sensing washer, and the torque or clamping force can be measured accurately to achieve a quick locking effect while monitoring the locking status afterward and allowing users to know whether the torque or clamping force is matched with or maintained within the expected permissible safety range.

The sensing locking element 1 completes the tightening operation by means of a power torque tool 2. In a preferred embodiment of the present invention, the programmable torque control method is applied to a car wheel 3, and the sensing locking element 1 is a sensing bolt having a screw head 10, a screw rod 11 axially extended from the screw head 10, and a sensing element 110 (such as a strain gauge) buried into the central axis of the screw rod 11 or the screw head 10 for detecting a sensing signal (such as a strain value generally in terms of voltage) generated according to a deformation caused by the applied torque during the process of tightening the sensing locking element 1, so that the linear relationship between the corresponding torque or clamping force required for the locking effect and the strain value can be used to control the magnitude of the torque or clamping force for the locking effect. The sensing element 110 is electrically coupled to a signal transmitting unit 100 through a transmission line 12 for transmitting the sensed strain signal generated by the sensing element 110 to the signal transmitting unit 100 through the transmission line 12. In FIG. 2, a plurality of sensing locking elements 1 is coupled to the same signal transmitting unit 100.

In FIG. 1, the power torque tool 2 is an impact or hydraulic pulse torque tool having an electric or pneumatic power source and the power torque tool 2 is provided for tightening one of the aforementioned sensing locking elements 1 to a desire level of clamping force, and the torque is a means for producing the clamping force. In the present invention, the power torque tool 2 comprises a controller 20 that controls a driving motor 21 of the power torque tool 2 to rotate forward and backward by a programmable method and sets a target torque value. The controller 20 can transmit a sensing signal of the sensing element 110 to the signal transmitting unit 100. After the sensing signal is converted into a numeric value, the numeric value of the sensing signal is computed and compared with the target torque value. If the numeric value of the sensing signal has not reached the current torque value, the controller 20 will control the driving motor 21 of the power torque tool 2 to rotate forward to keep tightening the sensing locking element 1, until the numeric value of the sensing signal has reached the target torque value, and then the controller 20 controls the driving motor 21 to stop and resets the sensing signal transmitted from the sensing element 110, so as to complete the tightening operation.

However, if the forward rotation of the driving motor 21 exceeds a default value (or the numeric value of the sensing signal exceeds the target torque value) in the aforementioned tightening operation, the controller 20 will control the driving motor 21 to rotate backward and drive the power torque tool 2 to loosen the sensing locking element 1. The controller 2 will keep receiving the sensing signals to determine and control the programmable continuous motion of the driving motor 21 to make forward or backward rotation, until the torque or clamping force for the tightening operation has reached the default target torque value, and then the controller 20 controls the driving motor 21 to stop or disconnect the power source.

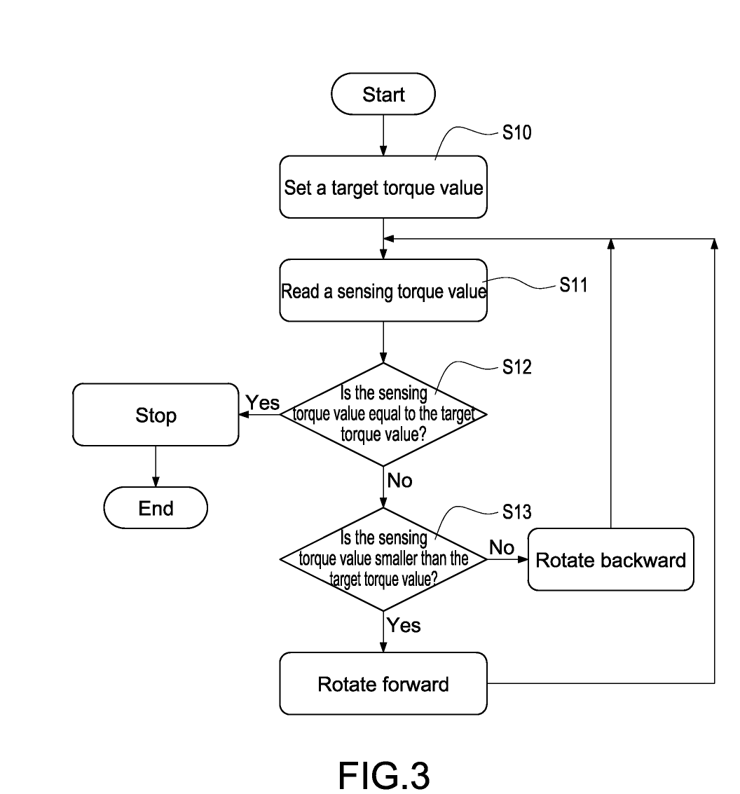

With reference to FIG. 3 for a block flow diagram of a controller programmable method in accordance with the first preferred embodiment of the present invention, the method comprises the following steps:

S10: Set a target torque value on the controller 20.

S11: Receive a sensing signal transmitted from the sensing element 110 to the signal transmitting unit 100 by the controller 20 to read a torque sensing value.

S12: Determine whether the torque sensing value is equal to the target torque value. If so (in other words, the torque sensing value has reached the target torque value), then the tightening torque or clamping force has reached the predetermined target torque value, and the controller 20 will stop the driving motor 21 of the power torque tool 2 or disconnect the power source, or else (in other words, the torque sensing value has not reached or exceeded then target torque value) the tightening torque or clamping force is not equal to the predetermined target torque value (in other words, the tightening torque or clamping force has not reached or has exceeded the target value).

S13: Determine whether the torque sensing value is smaller than the target torque value again by the controller 20. If so, then the driving motor 21 will be controlled to rotate forward, or else the driving motor 21 will be controlled to rotate backward instead, and will return to the step S11 until the step S12 determines that the torque sensing value is equal to the target torque value before the driving motor 21 is stopped or the power source is disconnected.

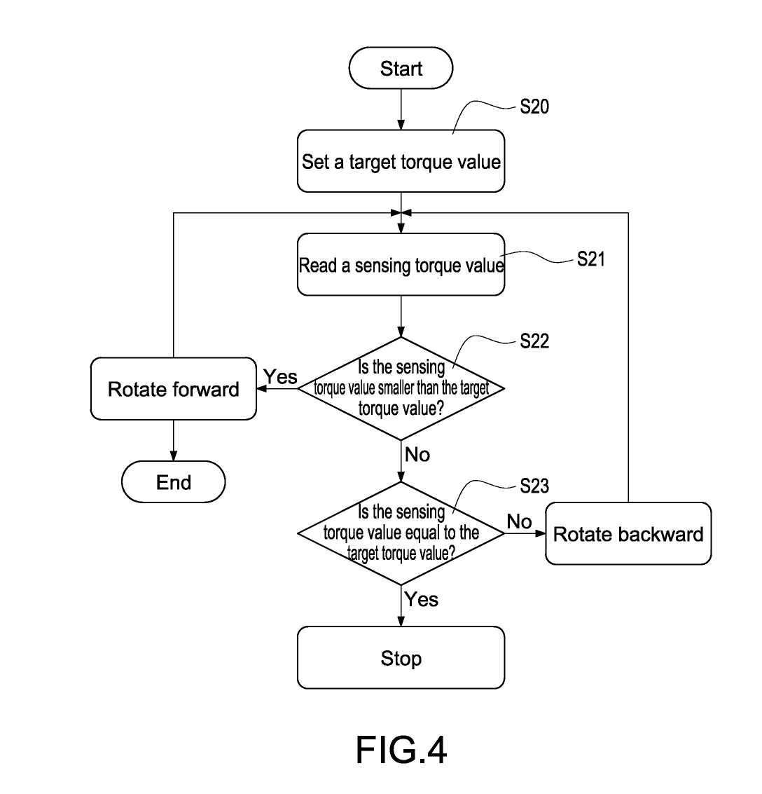

With reference to FIG. 4 for a block flow diagram of a controller programmable method in accordance with the second preferred embodiment of the present invention, the method comprises the following steps:

S20: Set a target torque value on the controller 20 as described above.

S21: Received a sensing signal transmitted from the sensing element 110 to the signal transmitting unit 100 by the controller 20 to read a torque sensing value.

S22: Determine whether the torque sensing value is smaller than the target torque value. If yes (in other words, the torque sensing value has not reached the target torque value), then the locking torque or clamping force has not reached the predetermined target torque value, and the controller 20 will control the driving motor 21 of the power torque tool 2 to rotate forward continuously until the torque sensing value is greater than (or not smaller than) the target torque value.

S23: Determine whether the torque sensing value is equal to the target torque value. If not (in other words, the torque sensing value exceeds the target torque value), then the torque or clamping force for the locking has exceeded the default target torque value, so that the controller 20 will control the driving motor 21 of the power torque tool 2 to rotate backward instead. Repeat the step S21 until the step S23 determines that the torque sensing value is equal to the target torque value, and then the driving motor 21 is stopped or the power source is disconnected.

In addition, the controller 20 is connected to a display device (not shown in the figure) for displaying the numeric value of the sensing signal, so that the operator will know whether the clamping level of the sensing locking element 1 falls within the expected safety range. The signal transmitting unit 100 can transmit the sensing signal to the controller 20 via a cable or wireless transmission. In a preferred embodiment of the present invention, the sensing signal is transmitted via the wireless transmission. If the cable transmission is adopted instead, the controller 20 can be plugged to the signal transmitting unit 100 through a detachable means such as a connector for reading the sensing signal.

In FIG. 1, the sensing locking element 1 can be an identity (ID) element and the identity (ID) element can further include a radio frequency identification (RFID) element with an identification function. In the meantime, the sensing locking element 1 can further include an accelerometer installed thereon, so that when the torque tool 2 is in contact with the sensing locking element 1, a vibration produced by the contact will trigger the accelerometer to drive the signal transmitting unit 100 to issue and transmit a sensing signal to the controller 20.

The steps described above constitute the programmable torque control method for controlling the tightening torque by means of sensing a locking element of the present invention.

In summation of the description above, the present invention achieves the expected objectives and overcomes the drawbacks of the prior art, and the invention complies with patent application requirements, and is thus duly filed for patent application.

While the invention has been described by means of specific embodiments, numerous modifications and variations could be made thereto by those skilled in the art without departing from the scope and spirit of the invention set forth in the claims.

What is claimed is:

1. A programmable torque control method for sensing locking element, comprising the steps of:
(a) providing at least one sensing locking element, and a power torque tool, and the sensing locking element having a signal transmitting unit, and the power torque tool having a controller for controlling forward and backward rotations of a driving motor of the power torque tool;
(b) using the power torque tool to tighten the sensing locking element to a desired position, and transmitting a sensed strain signal generated by the sensing locking element when the sensing locking element is deformed by a torque exerted thereon to the signal transmitting unit, and then transmitting the sensing signal from the signal transmitting unit to the controller;
(c) providing a target torque value to the controller, computing and comparing the sensed strain signal received from the signal transmitting unit by the controller, and if the sensed strain signal is smaller than the predetermined torque value, the driving motor will be controlled to rotate forward; and if the sensed strain signal is not smaller than the predetermined torque value, the driving motor will be controlled to rotate backward;
(d) repeating the step (c) until the sensed strain signal falls within a range of the predetermined torque value, and then stopping the driving motor.

2. The programmable torque control method for sensing locking element according to claim 1, wherein the sensing locking element comes with a plural quantity, and the same signal transmitting unit can be used for transmitting the sensing signal.

3. The programmable torque control method for sensing locking element according to claim 2, wherein the sensing locking element includes an identity (ID) element installed thereon.

4. The programmable torque control method for sensing locking element according to claim 3, wherein the identity (ID) element further includes a radio frequency identification (RFID) element.

5. The programmable torque control method for sensing locking element according to claim 1, wherein the sensing locking element includes an accelerometer installed thereon.

6. The programmable torque control method for sensing locking element according to claim 1, wherein the sensing locking element is a sensing bolt or a sensing washer.

7. The programmable torque control method for sensing locking element according to claim 1, wherein the signal transmitting unit transmits the sensing signal to the controller via a cable or wireless transmission.
